(19) United States
(12) Patent Application Publication
(10) Pub. No.: US 2008/0112121 A1
(43) Pub. Date: May 15, 2008

(54) Power supply device mounting structure and its mounting procedure

(76) Inventor: Ching-Liang Cheng, Hsin Chuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/599,327

(22) Filed: Nov. 15, 2006

(51) Int. Cl. G06F 1/16

(52) U.S. Cl. 361/683

(57) ABSTRACT

A power supply device mounting structure includes a circuit board, which has two rows of pins arranged in parallel at the top side for power input and a bottom power connector connectable to a power connector on a motherboard for power output, and A DC-to-DC Power Module, which is connected to a power adapter for power input and has three rows of pins arranged in parallel at the power output side thereof and selectively electrically connectable with two rows of pins of the three rows of pins of the DC-to-DC power module to the two rows of pins of the circuit board for DC output to the circuit board and then the motherboard.

### BACKGROUND OF THE INVENTION

1. Field of the Invention

The present invention relates to a power supply device mounting structure and its mounting procedure for personal computer which particularly apply to power connectors of all varieties of motherboards, allowing the reducing of the dimension of the computer case.

2. Description of the Related Art

Following the market trend toward a small-sized design for computers, the dimension of the motherboard for a computer is greatly reduced. In consequence, the dimension of the computer case is relatively reduced. The power supply unit of a computer has a great concern with the dimension of the computer case.

FIGS. 1 and 2 show a DC-to-DC power supply module 14 used in a mini personal computer 10. The DC-to-DC power supply module 14 has one end electrically connected to a power adapter 18, and the other end electrically connected to the motherboard 12 through a power cable 16.

In FIG. 3, the DC-to-DC power supply module 14 is directly connected to a power connector 122 at the motherboard 12 without through a power cable. This design saves a lot of installation space for the DC-to-DC power supply module 14; therefore, the dimension of the computer case for the mini personal computer 10 is greatly reduced.

The aforesaid power supply module installation arrangement allows the reducing of the dimension of the computer case. However, the mounting direction of the DC-to-DC power supply module 14 is subject to the design of the power connector 122 at the motherboard 12. When the DC-to-DC power supply module 14 is installed in the power connector 122 of the motherboard 12 shown in FIG. 4, the DC-to-DC power supply module 14 protrudes sideways over the area corresponding to the top wall of the motherboard 12. In this case, the dimension of the computer case cannot be minimized.

Therefore, it is desirable to provide a power supply unit and its mounting arrangement for computers, which apply to different directions of power sockets for motherboards and allows the reducing of the dimension of the computer case.

### SUMMARY OF THE INVENTION

The present invention has been accomplished under the circumstances in view. The main object of the present invention is to provide a power supply device mounting structure and its mounting procedure, which apply to the power connectors of all varieties of motherboards, allowing the reducing of the dimension of the computer case.

The power supply device mounting structure in accordance with the present invention comprises the circuit board and DC-to-DC power module. The circuit board has two row pins arranged in parallel at the topside for power input, and a bottom power receptacle connects to a power connector on a motherboard for power output. The DC-to-DC power module connected to a power adapter for power input has three row pins arranged in parallel at the power output side, and it selectively electrically connects two row pins of the three row pins on the DC-to-DC power module to the two row pins of the circuit board for DC output; moreover, the circuit board connects to the motherboard sequentially.

Furthermore, the power supply device mounting procedure includes the step of connecting the power receptacle of the circuit board to the power connector on the motherboard, and the step of selectively and electrically connecting two of the three row pins of the DC-to-DC power module to the two row pins of the circuit board.

### BRIEF DESCRIPTION OF THE DRAWINGS

FIG. 1 is a schematic drawing showing a mounting arrangement of a power supply module inside a computer according to the prior art.

FIG. 2 is a block diagram of FIG. 1.

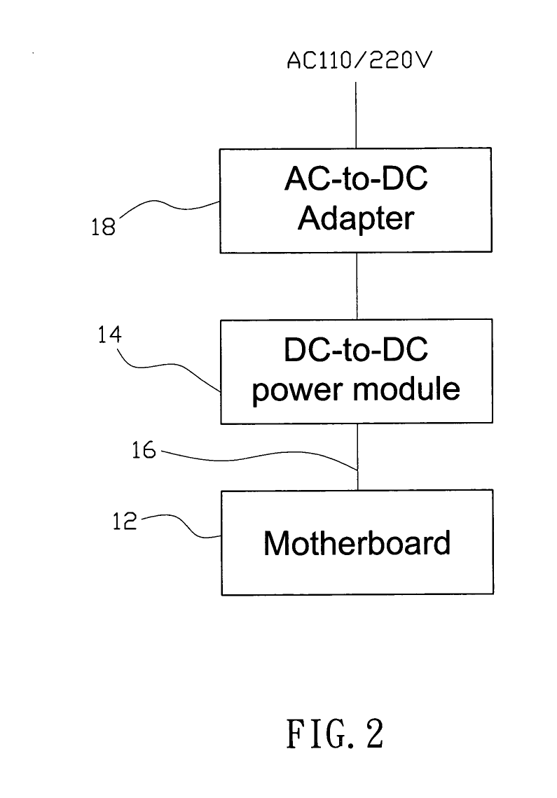

FIG. 3 is a schematic drawing showing another mounting arrangement of a power supply module inside a computer according to the prior art.

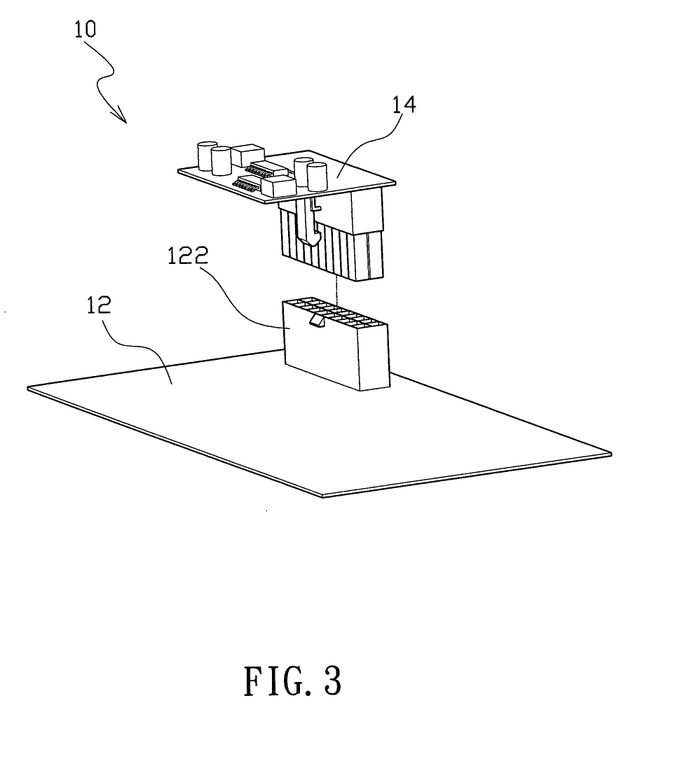

FIG. 4 is a schematic drawing showing still another mounting arrangement of a power supply module inside a computer according to the prior art.

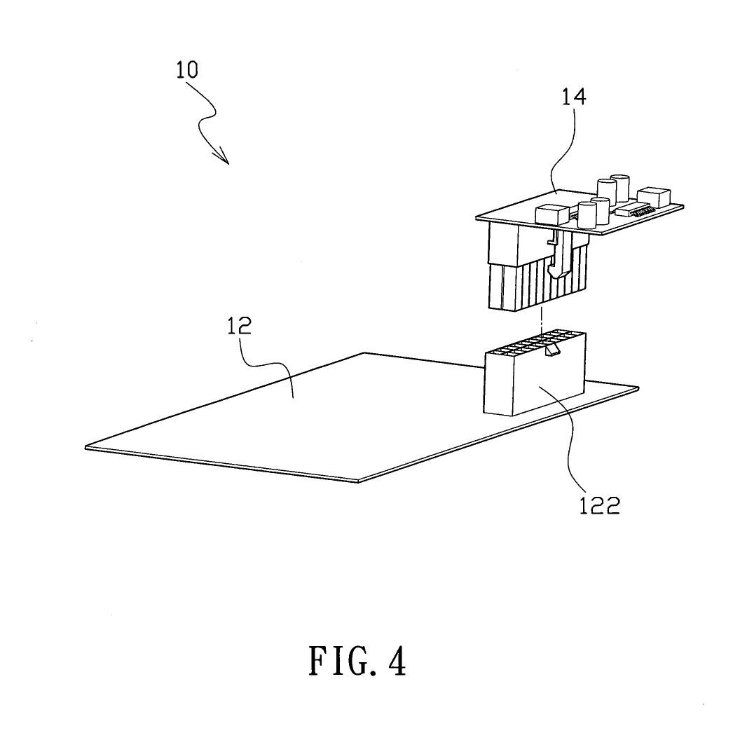

FIG. 5 is a schematic drawing showing one installation example of a power supply device mounting structure according to the present invention.

FIG. 6 is a schematic drawing showing another installation example of the power supply device mounting structure according to the present invention.

### DETAILED DESCRIPTION OF THE PREFERRED EMBODIMENT

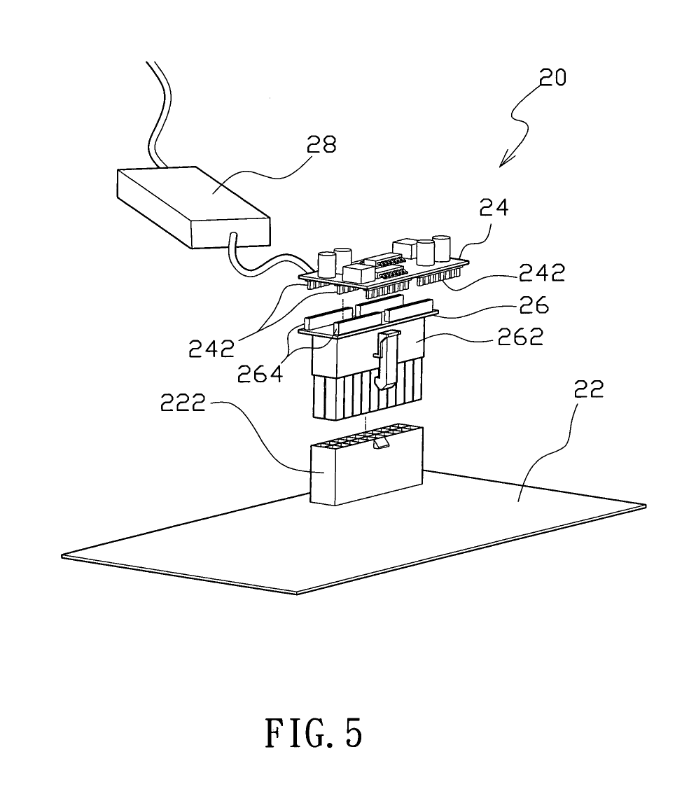

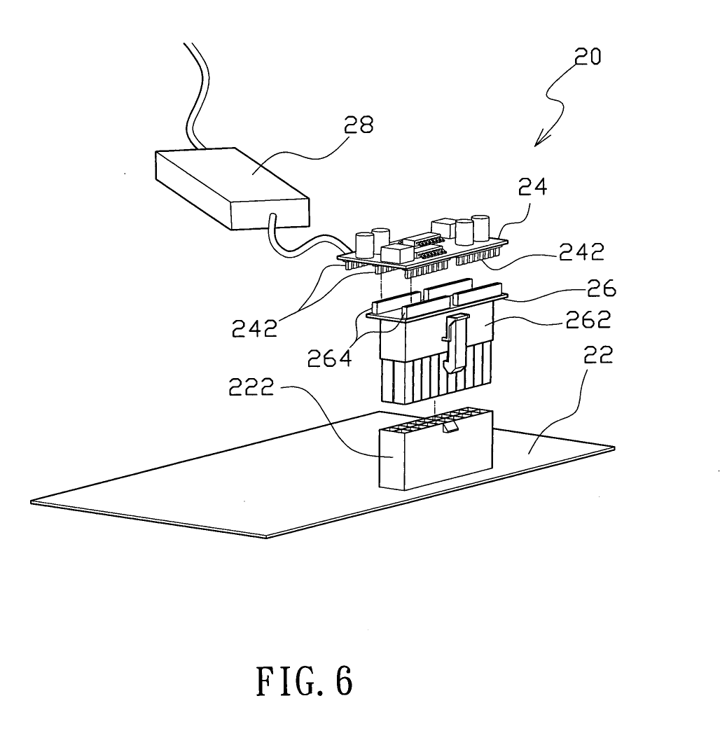

Referring to FIG. 5, a power supply device mounting structure in accordance with one embodiment of the present invention is shown for connection to a power connector 222 on the left side of a motherboard 22 (see FIG. 5) or the right side of a motherboard 22 (see FIG. 6). The power supply module mounting structure comprises a circuit board 26, which has a power receptacle 262 downwardly extended from the bottom side thereof for the connection to the power connector 222 of the motherboard 22 and two rows of female (or male) pins 264 of same definition arranged in parallel at the top side thereof. A power adapter 28 is adapted to convert AC power supply into DC power supply, and a DC-to-DC power supply module 24 has a power input side electrically connected to the power adapter 28 and a power output side electrically connected to the power connector 222 through the rows of female (or male) pins 264 and power receptacle 262 of the circuit board 26. The DC-to-DC power supply module 24 has three rows of male (or female) pins 242 of same definition arranged in parallel. Two adjacent rows of male (or female) pins 242 of the DC-to-DC power supply module 24 are electrically coupled to the two rows of female (or male) pins 264 of the circuit board 26 for output of DC power supply from the DC-to-DC power supply module 24 to the circuit board 26.

The power input side of the DC-to-DC power supply module 24 is electrically coupled to the power output side of the power adapter 28.

As stated above, the circuit board 26 has two rows of female (or male) pins 264 of same definition arranged in parallel at the top side for power input, and the DC-to-DC power supply module 24 has three rows of male (or female) pins 242 of same definition arranged in parallel corresponding to the two rows of female (or male) pins 264 of the circuit board 26 for power output. Any of the two adjacent rows of the three row male (or female) pins 242 of the DC-to-DC power supply module 24 can be selected for connection to the two row pins 264 of the circuit board 26 subject to the design (installation direction) of the power connector 222 on the motherboard 22.

Referring to FIG. 5, after installation of the power receptacle 262 of the circuit board 26 in a power connector 222 on the left side of a motherboard 22, two adjacent row male (or female) pins 242 of the DC-to-DC power supply module 24 are selected and then electrically connected to the female (or male) pins 264 of the circuit board 26. Furthermore, the power input side of the DC-to-DC power supply module 24 is electrically connected to the power adapter 28. When installed, the DC-to-DC power supply module 24 is kept above the motherboard 22 and within the covering area of the motherboard 22.

Referring to FIG. 6, after installation of the power receptacle 262 of the circuit board 26 in a power connector 222 on the right side of a motherboard 22, the other two adjacent rows of the three row male (or female) pins 242 of the DC-to-DC power supply module 24 are selected and then electrically connected to the female (or male) pins 264 of the circuit board 26. When installed, the DC-to-DC power supply module 24 is kept above the motherboard 22 and within the covering area of the motherboard 22.

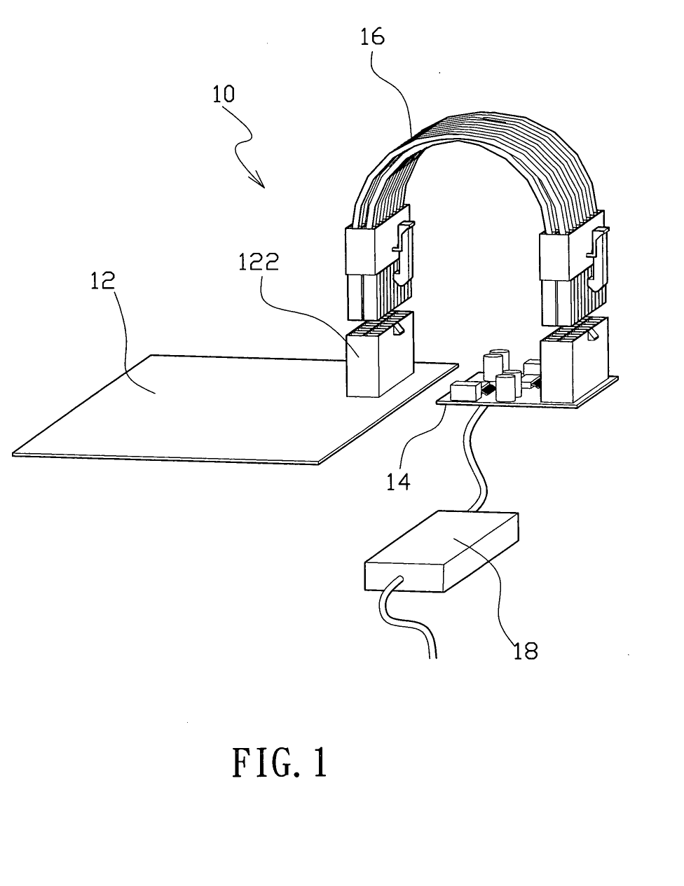

A prototype of power supply unit and its mounting procedure has been constructed with the features of FIGS. 1˜5. The power supply unit and its mounting procedure function smoothly to provide all of the features discussed earlier.

Although particular embodiments of the invention have been described in detail for purposes of illustration, various modifications and enhancements may be made without departing from the spirit and scope of the invention.

What the invention claimed is:

1. A power supply device mounting procedure for connecting a power adapter to a power connector on a motherboard with a power supply device comprised of A DC-to-DC Power Module having three parallel rows of pins of same definition and a circuit board having two parallel rows of pins at a top side and a power connector at a bottom side connectable to the power connector on said motherboard, the power supply device mounting procedure comprising the step of connecting the power connector of said circuit board to the power connector on said motherboard, and the step of selectively and electrically connecting two of the three rows of pins of said DC-to-DC power module to the two rows of pins of said circuit board.

2. The power supply device mounting procedure as claimed in claim 1, further comprising the step of electrically connecting a power input side of said DC-to-DC module to a power adapter.

3. The power supply device mounting procedure as claimed in claim 1, wherein the pins of said circuit board are respectively soldered to said circuit board.

4. The power supply device mounting procedure as claimed in claim 1, wherein the pins of said DC-to-DC power module are respectively soldered to said DC-to-DC power module.

5. The power supply device mounting procedure as claimed in claim 1, wherein the pins of said DC-to-DC power module are male pins, and the pins of said circuit board are female pins respectively selectively connectable to the male pins of said DC-to-DC power module.

6. A power supply device mounting structure comprising:
a circuit board, said circuit board comprising two rows of pins arranged in parallel at a top side thereof for power input and an power connector disposed at a bottom side thereof and electrically connected to the two rows of pins of said circuit board for connection to a power connector on a motherboard; and
A DC-to-DC Power Module, said DC-to-DC power module having a power input side, a power output side, and three rows of pins arranged in parallel at said power output side and electrically connected to said power input side and selectively electrically connectable with two rows of pins of said DC-to-DC power module to the two rows of pins of said circuit board.

7. The power supply device mounting structure as claimed in claim 6, wherein said power input side of said DC-to-DC power module is connected to a power output side of a power adapter.

8. The power supply device mounting structure as claimed in claim 6, wherein the pins of said DC-to-DC power module are respectively soldered to said DC-to-DC power module.

9. The power supply device mounting structure as claimed in claim 6, wherein the pins of said DC-to-DC power module are male pins, and the pins of said circuit board are female pins respectively selectively connectable to the male pins of said DC-to-DC power module.

10. The power supply device mounting structure as claimed in claim 6, wherein the pins of said DC-to-DC power module are male pins, and the pins of said circuit board are female pins respectively selectively connectable to the male pins of said DC-to-DC power module.
